(19) United States
(12) Patent Application Publication
(10) Pub. No.: US 2010/0174707 A1
(43) Pub. Date: Jul. 8, 2010

(54) IMAGE SEARCHING APPARATUS, IMAGE SORTING APPARATUS AND METHOD AND PROGRAM

(76) Inventors: Daiki Kudo, Tokyo (JP); Yoshiaki Kato, Tokyo (JP); Hirofumi Nishikawa, Tokyo (JP)

Correspondence Address: BIRCH STEWART KOLASCH & BIRCH, PO BOX 747, FALLS CHURCH, VA, 22040-0747, US

(21) Appl. No.: 12/666,564

(22) PCT Filed: Sep. 3, 2008
(86) PCT No.: PCT/JP2008/002415

§ 371 Date: Dec. 23, 2009

(30) Foreign Application Priority Data
Sep. 7, 2007 (JP) 2007-232973

(51) Int. Cl. G06F 17/30

(52) U.S. Cl. 707/723; 707/769; 707/737; 707/752; 707/E17.03; 707/722; 707/749; 707/E17.089

(57) ABSTRACT

An apparatus has a feature value extracting section 106 for extracting a feature value from a search key image; a distance calculating section 107 for calculating distances between the feature values of search target images and the feature value of the search key image; a distance analyzing section 108 for analyzing the distances calculated by the distance calculating section 107, and for selecting a feature value having a feature similar to the search key image as a feature value effective for the image search; and a search executing section 109 for arranging the search target images in a feature value space with coordinate axes to which a principal component analysis result of the feature value effective for the image search is assigned, and for searching for an image similar to the search key image from within the feature value space.

### TECHNICAL FIELD

The present invention relates to an image searching apparatus, an image sorting apparatus, an image searching method using the apparatuses, and a program for causing a computer to function as the image sorting method and the apparatuses.

### BACKGROUND ART

Conventionally, to carry out searching or sorting of images, a method using a keyword associated with each image is common. The method, however, must set keywords for all the images even when there is a mass of image data to be searched or sorted. Thus, it takes an enormous amount of time and labor to complete the image searching or sorting. In addition, since only images associated with the keyword that agrees with a search keyword are extracted as a list, it has a disadvantage of making it difficult to distinguish a desired image.

As a technique for eliminating such a conventional difficulty, there is a method disclosed in Patent Document 1, for example. The method sorts the images based on clustering results of feature values of image data. The method makes it possible to sort deeply connected image data into the same clusters without setting any external standards such as keywords. Here, as the feature values extracted from images, there are a color tone of an image as a whole, an aspect ratio, a distribution state of luminance or colors, a distribution state of edges and a distribution state of flat areas.

On the other hand, patent Document 2 performs principal component analysis of the feature values extracted from images, clusters the individual images into a plurality of clusters by considering the images as points within a metric space having the two-dimensional feature values as the two axes, and decides the display position or display size of the search resultant images using the clustering information. This makes it possible to show the searched images to a user as a list on a screen of a display apparatus without setting external standards such as keywords. According to the method, when a search request of images similar to a target image is made, it carries out the principal component analysis by extracting the feature values from the target image, and arranges the images in the metric space having the feature values as the two axes, thereby being able to show similar images.

Patent Document 1: Japanese Patent Laid-Open No. 2001-256244.

Patent Document 2: Japanese Patent Laid-Open No. 2005-235041.

Although the conventional methods perform clustering by the feature values of the images, it is unclear whether the feature values correspond to the images a user desires actually. Thus, they have a problem in that they cannot achieve an appropriate search or sort result the user intended in some cases.

For example, Patent Document 1 does not fully disclose a method of clustering by using the feature values extracted from the images. In addition, when a user request is made for searching for images similar to a particular image, it does not describe a method of the way of using the sorted images and which cluster images are to be shown to the user. Accordingly, it cannot always achieve an effective search or sort result.

In addition, Patent Document 2 does not clearly describe locations in the images, from which the various types of feature values are extracted, the meaning of the dimensional axes of the feature values resulting from the principal component analysis, or whether the sorting using them are effective for the user. Accordingly, it cannot always achieve an effective search or sort result.

The present invention is implemented to solve the foregoing problems. Therefore it is an object of the present invention to provide an image searching apparatus, an image sorting apparatus, an image searching method using the apparatuses, and a program for causing a computer to function as the image sorting method and the apparatuses capable of obtaining sorting or search results a user intends appropriately and quickly by selecting feature values effective for image searching or sorting.

### DISCLOSURE OF THE INVENTION

An image searching apparatus in accordance with the present invention includes: an image storage section for storing search target images; a feature value storage section for storing feature values of the search target images; a principal component storage section for storing principal component analysis results of the feature values of the search target images; a feature value extracting section for extracting a feature value from a search key image; a distance calculating section for calculating distances between the feature values of the search target images stored in the feature value storage section and the feature value of the search key image; a distance analyzing section for analyzing the distances calculated by the distance calculating section, and for selecting a feature value of the search target images having a feature similar to the search key image as a feature value effective for the image search; and a search executing section for arranging the search target images in a feature value space with coordinate axes to which a principal component analysis result of the feature value effective for the image search is assigned, and for searching for an image similar to the search key image from within the feature value space.

According to the present invention, it includes: an image storage section for storing search target images; a feature value storage section for storing feature values of the search target images; a principal component storage section for storing principal component analysis results of the feature values of the search target images; a feature value extracting section for extracting a feature value from a search key image; a distance calculating section for calculating distances between the feature values of the search target images stored in the feature value storage section and the feature value of the search key image; a distance analyzing section for analyzing the distances calculated by the distance calculating section, and for selecting a feature value of the search target images having a feature similar to the search key image as a feature value effective for the image search; and a search executing section for arranging the search target images in a feature value space with coordinate axes to which a principal component analysis result of the feature value effective for the image search is assigned, and for searching for an image similar to the search key image from within the feature value space. Thus, it selects a feature value effective for the image search from the feature values extracted from the search target images, and executes the image search in the feature value space constructed using the principal component analysis result of the feature value, thereby offering an advantage of being able to obtain a search result a user intends appropriately and quickly.

### BRIEF DESCRIPTION OF THE DRAWINGS

FIG. 1 is a block diagram showing a configuration of a search data creating apparatus for creating image data for a search used in the present invention;

FIG. 2 is a flowchart showing a flow of the processing of the search data creating apparatus in FIG. 1;

FIG. 3 is a block diagram showing a configuration of an image searching apparatus of an embodiment 1 in accordance with the present invention;

FIG. 4 is a flowchart showing a flow of the image search processing by the image searching apparatus in FIG. 3;

FIG. 5 is a table showing an example of distances between the feature value of a search key image and stored feature values;

FIG. 6 is a diagram showing results of an image search in a two-dimensional feature value space using the principal component data on feature values;

FIG. 7 is a diagram showing another results of an image search in a two-dimensional feature value space using the principal component data on feature values;

FIG. 8 is a block diagram showing a configuration of an image searching apparatus of an embodiment 2 in accordance with the present invention;

FIG. 9 is a flowchart showing a flow of the search processing by the image searching apparatus in FIG. 8;

FIG. 10 is a block diagram showing a configuration of an image sorting apparatus of an embodiment 3 in accordance with the present invention;

FIG. 11 is a flowchart showing a flow of the image sorting processing by the image sorting apparatus in FIG. 10;

FIG. 12 is a diagram showing results of an image sorting in a two-dimensional feature value space using the principal component data on feature values;

FIG. 13 is a block diagram showing a configuration of an image sorting apparatus of an embodiment 4 in accordance with the present invention; and

FIG. 14 is a flowchart showing a flow of the image sorting processing by the image sorting apparatus in FIG. 13.

### BEST MODE FOR CARRYING OUT THE INVENTION

The best mode for carrying out the invention will now be described with reference to the accompanying drawings to explain the present invention in more detail.

### Embodiment 1

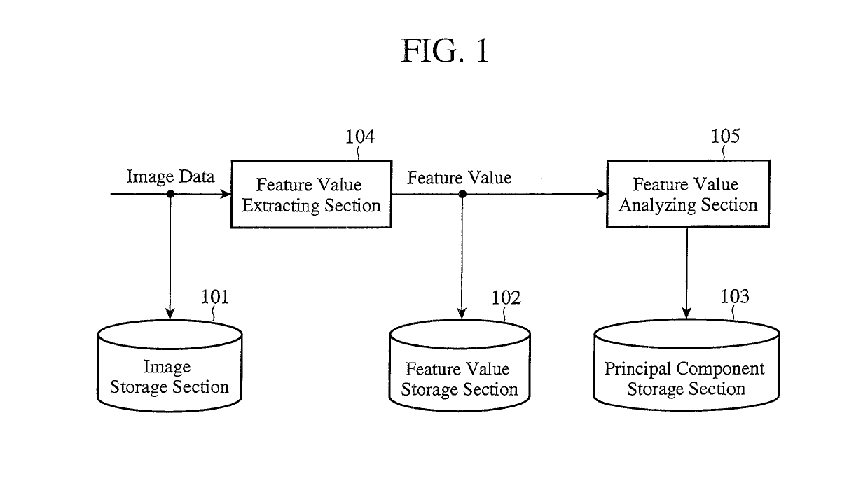

FIG. 1 is a block diagram showing a configuration of a search data creating apparatus for creating image data for a search used in the present invention. In FIG. 1, the search data creating apparatus has an image storage section 101, a feature value storage section 102, a principal component storage section 103, a feature value extracting section 104 and a feature value analyzing section 105. The image storage section 101 is a storage section for storing image data. The feature value storage section 102 is a storage section for storing the feature values of the image data. The principal component storage section 103 is a storage section for storing the results of the principal component analysis of the feature values of the image data.

The feature value extracting section 104 extracts the feature values of the image data to be searched. The feature values of the images to be extracted include color histograms, rough arrangement of colors, frequency components, texture and its arrangement, shapes of objects in the image and so on. A concrete example of the feature value is an Edge Histogram described in Reference 1. It converts local edge information into a histogram, which corresponds to the texture arrangement and feature values relating to its quantity.

Reference 1: Journal of the Institute of Image and Television Engineers Vol. 56, No. 11, pp. 1711-1714 (2002).

The feature value analyzing section 105 carries out the principal component analysis of the feature values of image data on the search target. The principal component analysis is one of the multivariate analysis techniques, which tries to describe the features of the target with a smaller number of variates by eliminating the correlation among the variates by linear transformation when multivariate measured values have been obtained.

The foregoing feature value extracting section 104 and feature value analyzing section 105 can be implemented as a concrete means in which software and hardware cooperate on a computer by causing the computer to read a feature value extraction/analysis program conforming the subject of the present invention and to control its operation.

In addition, the image storage section 101, feature value storage section 102 and principal component storage section 103 can be constructed on a storage area of a storage device installed in the computer, or on a storage area of a storage device of an external data server capable of data communication from the feature value extracting section 104 and feature value analyzing section 105.

Next, the processing of creating the image data for search will be described.

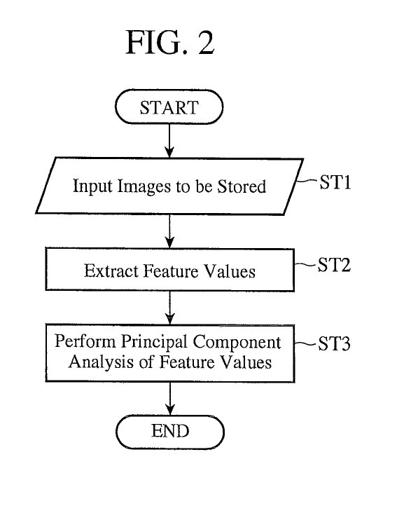

FIG. 2 is a flowchart showing a flow of the processing by the search data creating apparatus in FIG. 1. Referring to FIG. 2, details of the processing of creating the image data for search will be described.

First, the image data to be searched input from the outside of the apparatus is input to the image storage section 101. For example, assume that m sheets of image data are input here. In this case, the feature value extracting section 104 acquires the image data stored in the image storage section 101 at the same time (step ST1), and extracts the feature values of the image data (step ST2).

The feature value extracting section 104 stores the feature values extracted from the image data in the feature value storage section 102. Incidentally, the image data to be searched and their feature values are stored in the feature value storage section 102 with connections between them being established. In the following description, the image data stored in the image storage section 101 are referred to as “stored image” and the feature values of the stored image stored in the feature value storage section 102 are referred to as “stored feature values” as the occasion may demand.

At step ST2, the feature value extracting section 104 calculates a plurality of feature values from the stored images to meet various intentions of a user. Here, assume that it extracts n feature values. Next, the feature value analyzing section 105 receives the n feature values extracted from the m sheets of the stored images by the feature value extracting section 104, and performs the principal component analysis on each of the n feature values (step ST3). Incidentally, the feature values often have a plurality of variates.

For example, the Edge Histogram has 80 variates. Assume that a particular feature value has k variates and these variates are denoted by xᵢ (i=1, 2, 3, . . . , k). As to xᵢ, the principal component analysis is performed. The principal components Zᵢ (i=1, 2, 3, . . . , k) can be expressed by simultaneous equations given by the following expression (1). When all the k variates x₁, x₂, . . . , xₖ have the same unit, the simultaneous equations can be solved by obtaining eigenvalues using a variance covariance matrix. When they have different units, a correlation matrix can be used.

$$\begin{matrix}[ Expression 1 ] & \\ \{ \begin{matrix}{Z}_{1} = {a}_{11} {x}_{1} + {a}_{12} {x}_{2} + … + {a}_{1 n} {x}_{n} \\ {Z}_{2} = {a}_{21} {x}_{1} + {a}_{22} {x}_{2} + … + {a}_{2 n} {x}_{n} \\ ⋮ \\ {Z}_{n} = {a}_{n 1} {x}_{1} + {a}_{n 2} {x}_{2} + … + {a}_{nn} {x}_{n}\end{matrix} \\ where \\ {a}_{i 1}^{2} + {a}_{i 2}^{2} + … + {a}_{i k}^{2} = 1 & ( 1 )\end{matrix}$$

The principal component analysis can also be performed using a plurality of feature values. For example, it is also possible to use the feature values having k₁ and k₂ variates each to calculate the principal components Zᵢ (i=1, 2, 3, . . . k₁+k₂). As for combinations of selecting i from n feature values, since there are A combinations as shown by the following expression (2), the number of the results of the principal component analysis is B at the maximum. Whether to actually perform the principal component analysis using a plurality of feature values or not is decided considering the application applied. The feature value analyzing section 105 stores in the principal component storage section 103 the individual feature values obtained as described above or the principal components Zᵢ, which are the results of the principal component analysis using the plurality of feature values, in connection with the feature values and the image data to be searched.

$$\begin{matrix}[ Expression 2 ] & \\ A = {}_{n} C {\text{?}}_{\text{?}} \\ B = \text{?} {}_{n} C {\text{?}}_{\text{?}} \\ \text{?} \text{indicates text missing or illegible when filed} & ( 2 )\end{matrix}$$

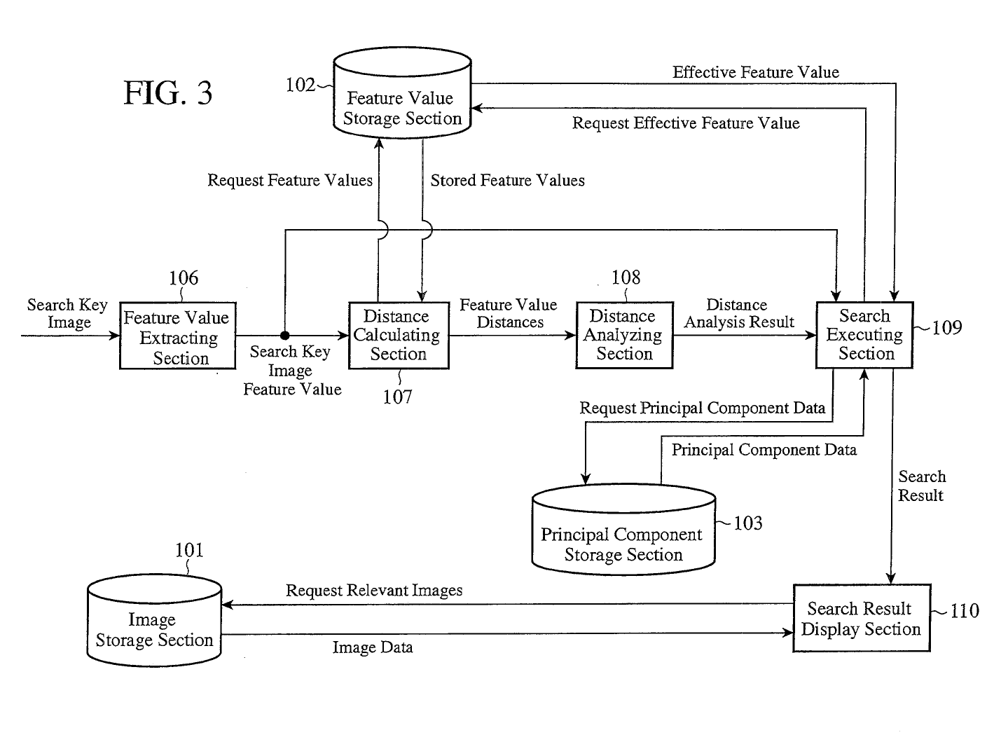

FIG. 3 is a block diagram showing a configuration of an image searching apparatus of the embodiment 1 in accordance with the present invention. In the following description, a case will be described in which the image searching apparatus of the embodiment 1 searches for an image similar to an image used as a search key (referred to as “search key image” from now on). In FIG. 3, the image searching apparatus of the embodiment 1 has an image storage section 101, a feature value storage section 102, a principal component storage section 103, a feature value extracting section 106, a distance calculating section 107, a distance analyzing section 108, a search executing section 109 and a search result display section 110.

The feature value extracting section 106 extracts feature values of a search key image (referred to as “search key image feature values” from now on) input from the outside of the apparatus. The feature values extracted by the feature value extracting section 106 include the same feature values as the feature values extracted by the feature value extracting section 104 of the search data creating apparatus shown in the FIG. 1. For example, if the feature value extracting section 104 extracts from the stored images the color histogram, rough arrangement of colors, frequency components, texture and its arrangement, and shapes of objects in each image as the feature values, the feature value extracting section 106 also extracts from the search key image the color histogram, rough arrangement of colors, frequency components, texture and its arrangement, and shapes of objects in the image.

The distance calculating section 107 calculates distances between the search key image feature values and the stored feature values in the feature value storage section 102 (referred to as “inter-key feature value distance” from now on). Here, as the inter-key feature value distance is shorter, the stored image is more similar to the search key image, and as the inter-key feature value distance is longer, the stored image is more dissimilar from the search key image.

The distance analyzing section 108 analyzes the inter-key feature value distances, and selects feature values effective for the image search. Here, the term “feature value effective for the image search” refers to a feature value capable of rejecting many images dissimilar from the search key image from a large amount of images, and is a feature value providing a feature similar to the search key image. For example, the distance analyzing section 108 obtains a distribution function of the inter-key feature value distances for each feature value, calculates analytic values indicating characteristics of the distribution functions, compares the analytic values, and selects the feature value of the distribution function that will give the analytic value corresponding to the least inter-key feature value distance as the feature value most effective for the image search.

In addition, the distance analyzing section 108 selects the feature value of the distribution function giving the analytic value corresponding to the second smallest inter-key feature value distance next to the most effective feature value as a second effective feature value (second effective feature value), and selects the feature value of the distribution function giving the next smallest analytic value as the third effective feature value. In this way, as to the feature values selected as the feature values effective for the image search, the distance analyzing section 108 ranks them in the order of validity in accordance with the degree of similarity to the search key image, and makes a distance analysis result.

The search executing section 109, using the principal component data on the effective feature values selected by the distance analyzing section 108, searches for an image similar to the search key image. The search result display section 110 displays on the display screen the image data resulting from the search by the search executing section 109 or the stored image data read from the image storage section 101.

As for the foregoing feature value extracting section 106, distance calculating section 107, distance analyzing section 108, search executing section 109 and search result display section 110, they can be implemented as a concrete means in which software and hardware cooperate on a computer by causing the computer to read an image searching program conforming the subject of the present invention and to control its operation.

In addition, the image storage section 101, feature value storage section 102 and principal component storage section 103 can be constructed on the storage area of the storage device installed in the computer, or constructed on the storage area of the storage device of the external data server capable of data communication from the distance calculating section 107, search executing section 109 and search result display section 110. Incidentally, in FIG. 3, the same components as those of FIG. 1 are designated by the same reference numerals and their description will be omitted.

Next, the image search processing will be described.

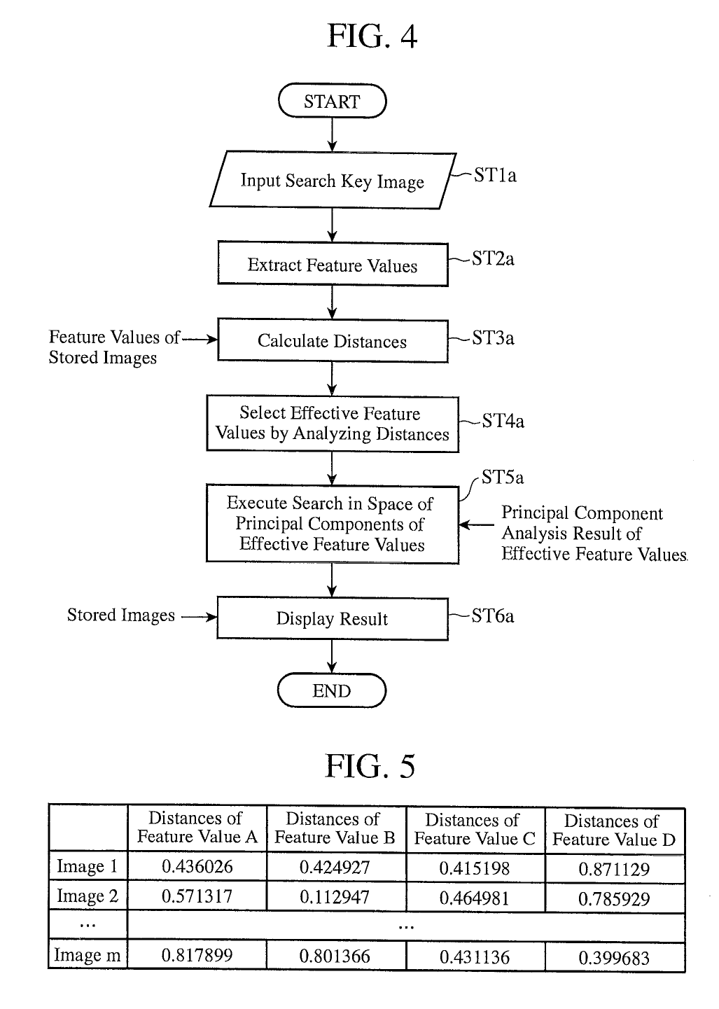

FIG. 4 is a flowchart showing a flow of the image search processing by the image searching apparatus in FIG. 3. Referring to FIG. 3 and FIG. 4, details of the processing will be described.

First, the feature value extracting section 106 receives the search key image from the outside of the apparatus (step ST1a), and extracts the feature values from the search key image (step ST2a). As for the feature values extracted here, they are the same feature values which are extracted by the feature value extracting section 104 of the search data creating apparatus shown in FIG. 1, and are stored in the feature value storage section 102.

Next, the distance calculating section 107, receiving the search key image feature values from the feature value extracting section 106, requests the stored feature values corresponding to the types of the feature values from the feature value storage section 102. Subsequently, the distance calculating section 107 calculates the inter-key feature value distances between the stored feature values read from the feature value storage section 102 in response to the request and the search key image feature values (step ST3a). Here, since there are m sheets of the stored images and n feature values, (m×n) inter-key feature value distances are calculated.

FIG. 5 is a table showing an example of the stored images and the inter-key feature value distances for each feature value, in which the feature values are A, B, C and D and their number is n=4. For example, in FIG. 5, the inter-key feature value distance between the feature value A of the stored image 1 and the feature value A of the search key image is 0.436026, and the inter-key feature value distance between the feature value B of the stored image 2 and the feature value B of the search key image is 0.112947. As for such a distance calculating method between the feature values, there are various methods for respective feature values (for respective types of the feature values). In the foregoing Edge Histogram, the feature value distance is calculated using a sum of absolute values of differences between individual histogram bins as described in Reference 1.

Subsequently, the distance analyzing section 108 analyzes the inter-key feature value distances calculated by the distance calculating section 107 to select the feature values effective for the image search (step ST4a). The analysis method of the feature value distance includes a method of obtaining a distribution function for each feature value distance, and using the mean and variance as the analytic values indicating the characteristics of the distribution function, for example. In the case of FIG. 5, as to the feature values A-D, the distribution functions of the inter-key feature value distances for the individual stored images 1, 2, . . . , m are obtained.

When the feature value distances between the search key image and each of the other large amount of stored images assume a positive value (in the Edge Histogram of the foregoing texture descriptor, the L1 normed sum of the individual variates is often used, which takes a positive value without exception), the inter-key feature value distances are considered to take logarithmic normal distribution. That the mean value in the logarithmic normal distribution is high means that the inter-key feature value distances are large, which means in turn that the images similar to the search key image is not many.

In contrast, a low mean value means that the inter-key feature value distances are small, which means that images similar to the search key image are many. In addition, the low variance in the logarithmic normal distribution of the inter-key feature value distances means that a large number of data (the inter-key feature value distances, here) concentrates in a region close to the mean value of the logarithmic normal distribution function.

Accordingly, if the mean value of the inter-key feature value distances is very high and the variance thereof is also high in the logarithmic normal distribution of the feature values, the feature values corresponding to the logarithmic normal distribution are values corresponding to the features of the images dissimilar from the search key image and are not effective for the image search. On the contrary, if the mean value of the inter-key feature value distances is low and the variance thereof is also low in the logarithmic normal distribution of the feature values, the feature values corresponding to the logarithmic normal distribution correspond to the features of the images similar to the search key image. The feature values are considered to be feature values that reject more stored images dissimilar from the search key image from the large amount of stored images, which can be said to be feature values effective for the image search.

The distance analyzing section 108 obtains the logarithmic normal distribution function of the inter-key feature value distances for each feature value, and calculates the mean value and variance, which are the analytic values indicating the characteristics of the distribution functions. Then, the distance analyzing section 108 compares the mean values and variances of the distribution functions, and selects the feature value of the distribution function that gives the minimum values of the mean value and variance corresponding to the smallest inter-key feature value distance as the most effective feature value for the image search.

In addition, the distance analyzing section 108 selects the feature value of the distribution function that gives the second smallest mean value and variance next to the mean value and variance of the distribution function that will gives the most effective feature value as the second effective feature value, and selects the feature value of the distribution function that gives the next smallest mean value and variance as the third effective feature value. In this way, the distance analyzing section 108 decides ranking of validity as to the feature values selected as the feature values effective for the image search, and makes them the distance analysis result.

Incidentally, as to the feature value distance analysis (effective feature value selection) by the distance analyzing section 108, a method other than that using the foregoing distribution function can be used.

The search executing section 109, receiving from the distance analyzing section 108 the information designating the feature values effective for the image search which are selected as the distance analysis result, requests the principal component data on the feature values effective for the image searching from the principal component storage section 103, and at the same time requests the feature values effective for the image search from the feature value storage section 102. Subsequently, the search executing section 109, receiving the principal component data on the feature values effective for the image search, which are read from the principal component storage section 103 in response to the request, and receiving the feature values effective for the image search read from the feature value storage section 102 in response to the request, actually searches for the image similar to the search key image using the data (step ST5a).

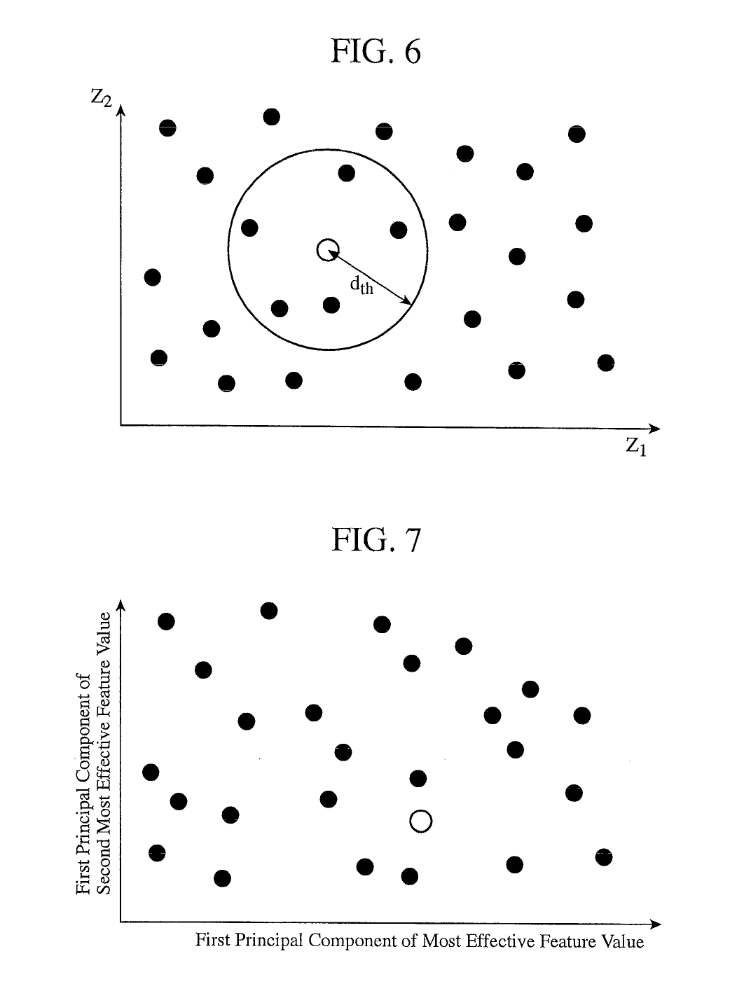

FIG. 6 is a diagram showing a result of an image search in the two-dimensional feature value space using the principal component data on the feature value, in which the horizontal axis shows the first principal component Z₁ of the feature value and the vertical axis shows the second principal component Z₂ thereof. In addition, in FIG. 6, the open circle denotes the principal component values of the feature value of the search key image, and closed circles denote the principal component values of the feature values effective for the image search read out of the principal component storage section 103.

As shown in FIG. 6, the search executing section 109 performs mapping of the feature values of the stored images and the search key image in the two-dimensional feature value space using the first principal component Z₁ and second principal component Z₂ of the feature value effective for the image search. In the two-dimensional searching space thus obtained, the search executing section 109 makes a decision that the images within a distance dₜₕ from the point of the search key image as images similar to the search key image, and outputs them to the search result display section 110 as a search result. In the example of FIG. 6, five stored images are decided as the images similar to the search key image.

In FIG. 6, although the images within the distance specified by the preset dₜₕ are searched, it is also possible to determine the number of sheets j of the images extracted as the images similar to the search key image in advance and to gradually change the extraction range specified by dₜₕ.

Furthermore, the feature value space using the principal component data on the feature values can be constructed as follows.

FIG. 7 is a diagram showing a result of an image search in the two-dimensional feature value space using the principal component data on the feature values, in which the horizontal axis shows the first principal component of the most effective feature value, and the vertical axis shows the first principal component of the next (second) effective feature value. In FIG. 7, the open circle denotes the principal component values of the feature values of the search key image, and closed circles denote the principal component values of the feature values effective for the image search read out of the principal component storage section 103.

As shown in FIG. 7, the search executing section 109 performs mapping of the feature values of the stored images and the search key image in the two-dimensional feature value space using the first principal component of the most effective feature value and the first principal component of the second effective feature value for the image search. In the two-dimensional feature value space thus obtained, the search executing section 109 can decide the image within the distance dₜₕ from the point of the search key image as the images similar to the search key image in the same manner as in FIG. 6, or decide the images similar to the search key image after deciding the number of sheets of them.

In addition, when the principal component analysis of a plurality of feature values have been carried out in advance, the search executing section 109 can make use of them.

Furthermore, the search executing section 109 can carry out the image search by constructing the searching space of a three-dimensional space or multidimensional space using the principal components of the feature values effective for the image search.

The search result display section 110, receiving the information designating the search resultant images from the search executing section 109, requests the images designated by the information from the image storage section 101. Next, the search result display section 110 receives the image data read out of the image storage section 101 in response to the request, and displays on the display screen (step ST6a). When displaying the search resultant images, it can display it along with the feature value space used for the search.

For example, in the two-dimensional feature value space shown in FIG. 6, along with the points, which correspond to the principal components of the individual feature values of the search key image and the images similar to it, thumbnails of the images are arranged. When the feature value space, into which the feature values of the stored images and the search key image are mapped, is three-dimensional, images can be displayed in the three-dimensional feature value space in thumbnails.

As described above, according to the present embodiment 1, since it comprises the image storage section 101 for storing the search target images, the feature value storage section 102 for storing the feature values of the search target images, the principal component storage section 103 for storing the principal component analysis results of the feature values of the search target images, the feature value extracting section 106 for extracting the feature values from the search key image, the distance calculating section 107 for calculating the distances between the feature values of the search target images stored in the feature value storage section 102 and the feature values of the search key image, the distance analyzing section 108 for analyzing the distances calculated by the distance calculating section 107 and for selecting the feature values of the search target images which give features similar to the search key image as the feature values effective for the image search, and the search executing section 109 for arranging the search target images in the feature value space having the principal component analysis result of the feature values effective for the image search set as the coordinate axes and for searching the feature value space for the images similar to the search key image, it can select the feature values effective for the image search, thereby being able to improve the accuracy of the image search.

In addition, according to the present embodiment 1, since it comprises the search result display section 110 for arranging the search result of the search executing section 109 in the feature value space and for displaying on the display screen, a user can look at the images similar to the search key image in an organized manner.

Furthermore, according to the present embodiment 1, since the distance analyzing section 108 decides ranking of the validity of the feature values effective for the image search in accordance with the degree of similarity to the search key image, and the search executing section 109 searches for the images similar to the search key image using the feature values effective for the image search, the ranking of which is decided by the distance analyzing section 108, it can obtain a variety of image search results in accordance with the order of validity.

### Embodiment 2

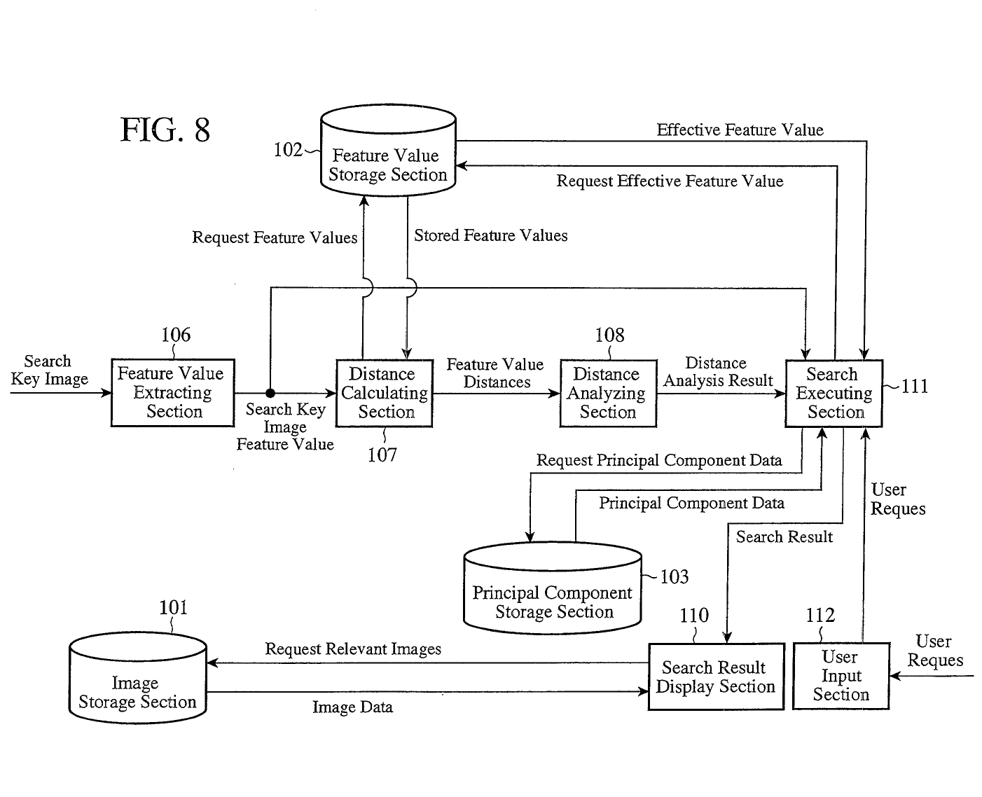

FIG. 8 is a block diagram showing a configuration of an image searching apparatus of an embodiment 2 in accordance with the present invention. In FIG. 8, the image searching apparatus of the embodiment 2 comprises a search executing section 111 and a user input section 112 in addition to the image storage section 101, feature value storage section 102, principal component storage section 103, feature value extracting section 106, distance calculating section 107, distance analyzing section 108 and search result display section 110 shown in FIG. 3 of the embodiment 1. The search executing section 111 searches for images similar to the search key image using the principal component data on the effective feature values selected by the distance analyzing section 108, and carries out the image searching in response to a user request input via the user input section 112.

The user input section 112, which is a component for a user to input information from the outside of the apparatus or to carry out selection and settings, is realized in a concrete system in which software executed by a computer operating as the image searching apparatus of the embodiment 2 cooperates with hardware such as a display and microphone. For example, it offers a GUI (Graphical User Interface) for inputting or selecting information by displaying a setting screen linked with a remote control on the display. Incidentally, in FIG. 8, the same components as those of FIG. 3 are designated by the same reference numerals and their description will be omitted here.

Next, the operation will be described.

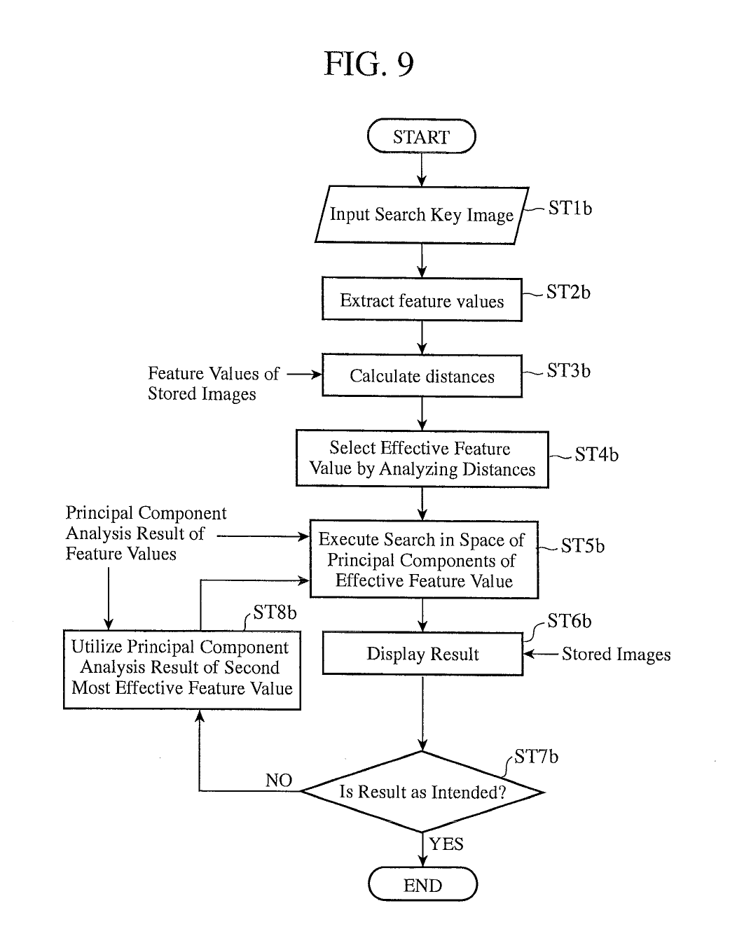

FIG. 9 is a flowchart showing a flow of the search processing by the image searching apparatus in FIG. 8. Referring to FIG. 8 and FIG. 9, details of the processing will be described.

First, the processing from step ST1b to step ST6b, which receives a search key image and displays a search result first on the display screen, is the same as the processing from step ST1a to step ST6a of FIG. 4 shown in the embodiment 1. While the search result is being displayed by the processing at step ST6b, the search executing section ill shifts to a reception state of a user request via the user input section 112.

The user confirms the search result displayed on the display screen by the search result display section 110 at step ST6b. If it is the result intended, the user inputs as a user request that it is the result he or she intended from the user input section 112, and if it differs from the result intended, the user inputs that effect from the user input section 112 as a user request.

The search executing section 111 makes a decision as to whether the user request input via the user input section 112 indicates that the search result is the result intended or differs from the result intended (step ST7b). Here, if the user request indicates that the search result is the one intended, the processing is completed on the assumption that the intended image search has been executed.

On the other hand, if the user request indicates that the search result differs from the one intended, the search executing section 111 requests the principal component storage section 103 to offer the principal component data of the feature value effective next to the feature value (second effective feature value) used in the preceding image searching, and requests the feature value from the feature value storage section 102. After that, the search executing section 111, receiving the principal component data on the second effective feature value read out of the principal component storage section 103 in response to the request, accepts the second effective feature value read out of the feature value storage section 102 in response to the request (step ST8b).

Subsequently, returning to step ST5b, the search executing section 111 actually searches for images similar to the search key image using the second effective feature value it receives at step ST8 band its principal component data. As for the execution procedure of the search, it is the same as that of the embodiment 1 except for the case where the data is the second effective feature value and its principal component data. In this way, in the present embodiment 2, the processing is repeated until the search result the user intends is obtained.

Incidentally, as the user request, the user can input the degree of difference from the intention, or the type of the intention concretely. For example, if the search result completely differs from the user intention, the user can input that effect as the user request. In this case, if the most effective feature value relates to colors and the second effective one is also a feature value relating to colors, the search executing section 111, considering that the second effective one with the same feature value will produce a similar search result, can skip the second effective feature value and use a third effective feature value.

By setting the degree it differs from the user intention in such a manner as large, medium and small, the search executing section 111 executes the image search using the feature value in the order of validity. In addition, when indicating what type of intentions the user requests, it is conceivable to designate a specific feature value by the user request. For example, among the images similar to the search key image, when the images similar in the feature values relating to colors are to be searched for, the feature values relating to colors are designated by the user request. Thus, the search executing section 111 searches for the images using the feature values relating to colors in the order of validity.

In addition, when different types of feature values are assigned to the individual coordinate axes in the feature value space used for the image search, it is also possible to alter the feature value assigned to one of the coordinate axes by the user request (alters the principal component data assigned to one of the coordinate axes or alters the type of the feature value itself).

As described above, according to the present embodiment 2, since it comprises the user input section 112 for inputting information from the outside of the apparatus, and the search executing section 111 for altering the feature value effective for the image search in response to the information input from the user input section 112, it can carry out the image search using the feature value resulting from the feedback of the user intention, thereby being able to show the search result more suitable for the user intention.

### Embodiment 3

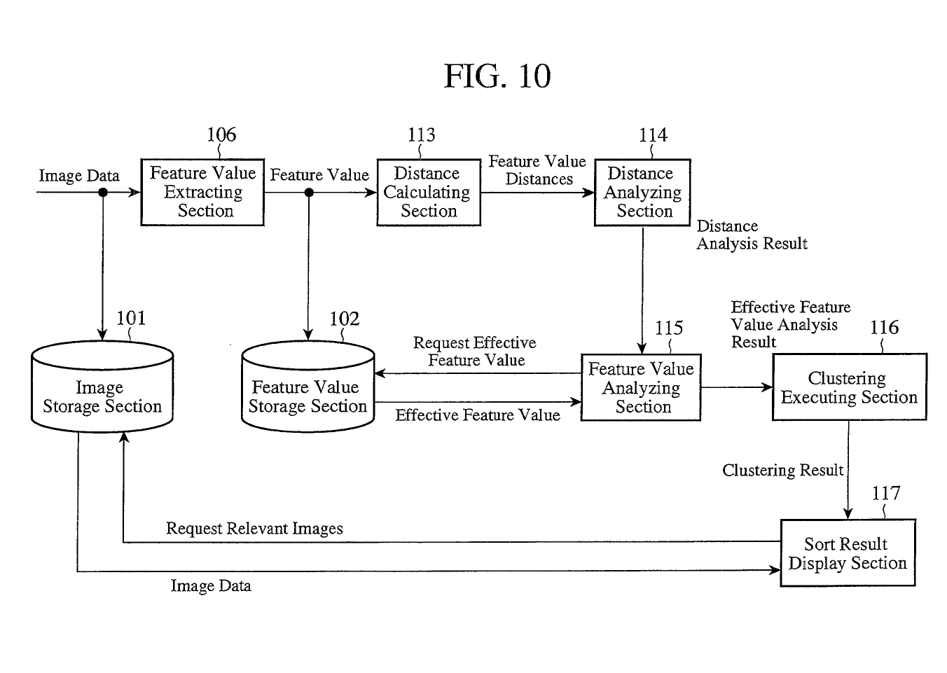

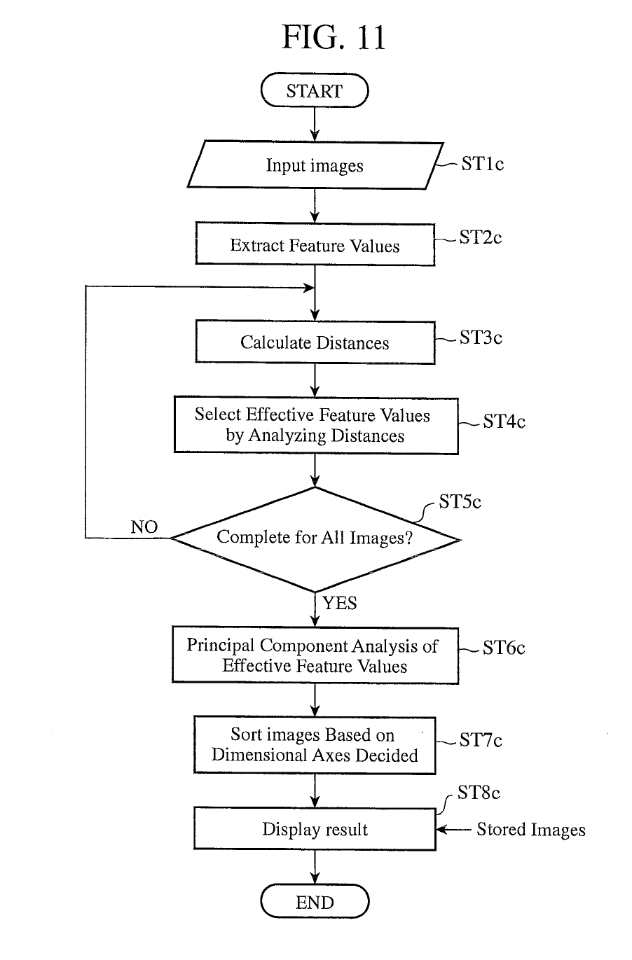

FIG. 10 is a block diagram showing a configuration of an image sorting apparatus of an embodiment 3 in accordance with the present invention. In the following description, a case will be shown which automatically sorts a large amount of image data by the image sorting apparatus of the embodiment 3. The image sorting apparatus of the present embodiment 3 comprises an image storage section 101, a feature value storage section 102, a feature value extracting section 106, a distance calculating section 113, a distance analyzing section 114, a feature value analyzing section 115, a clustering executing section 116 and a sort result display section 117. As for the image storage section 101 and feature value storage section 102, since they are the same as those of the embodiment 1, their description will be omitted here.

The feature value extracting section 106 extracts the feature values of image data input from the outside of the apparatus. The feature values include, for example, a color histogram, rough arrangement of colors, frequency components, texture and its arrangement, shapes of objects in an image and so on. In addition, as an example of the feature value, there is an Edge Histogram as described above.

The distance calculating section 113 calculates distances between the feature values of the individual images extracted by the feature value extracting section 106 (referred to as “feature value distance” from now on). Here, as the feature value distances become shorter, the stored images giving the feature value become more similar to each other, and as the feature value distances become longer, the stored images become more dissimilar.

The distance analyzing section 114 selects feature values effective for the image sorting by analyzing the feature value distances between the stored images input to the apparatus. The term “feature value effective for the image sorting” refers to a feature value capable of sorting the plurality of stored images into a greater number of groups, and a feature value that provides similar features among the plurality of stored images. For example, it obtains a distribution function of the feature value distances between the stored images for each feature value, calculates analytic values indicating the characteristics of the distribution functions, compares the analytic values, and selects as the most effective feature value for the image sorting the feature value of the distribution function which provides the analytic value corresponding to the shortest feature value distance.

In addition, the distance analyzing section 114 selects as the second effective feature value the feature value of the distribution function which provides the analytic value corresponding to the second shortest feature value distance next to the most effective feature value, and selects as the third effective feature value the feature value of the distribution function which provides the analytic value corresponding to the next shortest feature value distance. In this way, as to the feature values selected as the feature values effective for the image sorting, the distance analyzing section 114 decides ranking of validity in accordance with the degree of similarity among the stored images and makes it a distance analysis result.

The feature value analyzing section 115 performs the principal component analysis of the feature values decided as effective for the image sorting as a result of the distance analysis. Incidentally, the principal component analysis is a method of trying to describe the features of a target with a smaller number of variates by eliminating correlations among the variates by the linear transformation in the same manner as the embodiment 1 when the multivariate measured values are obtained.

The clustering executing section 116 sorts the images using the feature value effective for the image sorting and its principal component data. The sort result display section 117 displays on the display screen the sort results by the clustering executing section 116 or the stored image data read out of the image storage section 101.

As for the foregoing feature value extracting section 106, distance calculating section 113, distance analyzing section 114, feature value analyzing section 115, clustering executing section 116 and sort result display section 117, they can be implemented as a concrete means in which software and hardware cooperate on a computer by causing the computer to read an image sorting program conforming the subject of the present invention and to control its operation.

In addition, as for the image storage section 101 and feature value storage section 102, they can be constructed on the storage area of the storage device installed in the computer, or on the storage area of the storage device of an external data server capable of data communication from the feature value extracting section 106, distance calculating section 113, feature value analyzing section 115 and sort result display section 117.

Next, the operation will be described.

FIG. 11 is a flowchart showing a flow of the image sorting processing by the image sorting apparatus of FIG. 10. Details of the processing will now be described with reference to FIG. 10 and FIG. 11.

First, the image data on targets to be sorted input from the outside of the apparatus are supplied to the image storage section 101. Here, assume that the data on m sheets of images are input, for example. At the same time, the feature value extracting section 106 acquires the image data stored in the image storage section 101 (step ST1c), and extracts the feature values of the image data (step ST2c).

The feature value extracting section 106 stores the feature values extracted from the image data in the feature value storage section 102. Incidentally, the image data on the targets to be sorted and their feature values are stored in the feature value storage section 102 with connections between them being established. In the following description, the image data on the targets to be sorted stored in the image storage section 101 are referred to as “stored images”, and the feature values of the stored images in the feature value storage section 102 are referred to as “stored feature values” as the occasion may demand.

At step ST2c, the feature value extracting section 106 calculates a plurality of feature values from the stored images to deal with a variety of user intentions. Here, assume that n feature values are extracted. The feature values extracted here are stored in the feature value storage section 102 with connections with the stored image data in the image storage section 101 being established.

Next, the distance calculating section 113 requests the feature value storage section 102 to provide the feature values among the stored images extracted from the feature value extracting section 106. Subsequently, the distance calculating section 113 calculates the feature value distances between the stored images read out of the feature value storage section 102 in response to the request (step ST3c). Here, since there are m sheets of the stored images and n feature values, C distances shown in the following expression (3) are calculated.

$$\begin{matrix}[ Expression 3 ] & \\ C = n {\sum }_{i = 1}^{m} ( i - 1 ) & ( 3 )\end{matrix}$$

Subsequently, the distance analyzing section 114 analyzes the feature value distances between the individual stored images calculated by the distance calculating section 113, and selects the feature values effective for the image sorting (step ST4c). The analysis method of the feature value distances includes a method of obtaining a distribution function for each feature value distance in the same manner as the embodiment 1, and a method of using the mean value and variance as the analytic values indicating the features of the distribution function.

For example, the distance analyzing section 114 obtains the logarithmic normal distribution function of the feature value distances between a particular stored image and other stored images for each feature value, and calculates the mean value and variance, which are the analytic values indicating the characteristics of the distribution functions. Then, the distance analyzing section 114 compares the mean values and variances of the distribution functions, and selects as the most effective feature value for the image sorting as to the particular stored image the feature value of the distribution function that gives the minimum values of the mean value and variance corresponding to the smallest feature value distance.

The distance analyzing section 114 repeats the operation for obtaining the most effective feature value for the image sorting at step ST3c and step ST4c by the number of sheets of the stored images, that is, m times for the m sheets of the images (step ST5c). Thus, as to each of the m sheets of the stored images, the most effective feature value for the image sorting is obtained.

When completing the distance analysis for all the stored images, the feature values selected again and again as the feature values effective for the image sorting are distinguished from feature values not so. For example, a case can occur where the feature value of the color histogram is selected again and again as the most effective feature value, but the feature value relating to the texture arrangement is not selected at all. In this case, although the color histogram is effective for sorting prescribed stored images from all the stored image data, the feature value relating to the texture arrangement is not effective for the image sorting.

Then, the distance analyzing section 114 decides ranking as to which feature values are effective in accordance with the frequency selected as the most effective feature values for the image sorting, for example, and decides the feature values effective for the image sorting by weighting the individual ranks and by adding them. The information designating the feature values effective for the image sorting selected in this way is output from the distance analyzing section 114 to the feature value analyzing section 115 as the distance analysis result. Incidentally, the effective feature value or values designated as the distance analysis result can be single or plural.

The feature value analyzing section 115, receiving the information designating the feature values effective for the image sorting from the distance analyzing section 114 as the distance analysis result, requests the feature values from the feature value storage section 102. After that, the feature value analyzing section 115 acquires the feature values effective for the image sorting read out of the feature value storage section 102 in response to the request, and carries out the principal component analysis of the feature values (step ST6c). The result of the principal component analysis is supplied from the feature value analyzing section 115 to the clustering executing section 116.

In particular, when two or three feature values effective for the image sorting are designated, it is possible to carry out the principal component analysis for each of the feature values, and to assign the individual first principal components to the dimensional axes at a time of performing clustering. In addition, it is also possible to carry out the principal component analysis using all the effective feature values.

The clustering executing section 116, receiving the principal component analysis result of the feature values effective for the image sorting, causes the feature value analyzing section 115 to perform the principal component analysis of the feature values of all the stored images in the feature value storage section 102, and obtains the result. After that, the clustering executing section 116 constructs the feature value space with the coordinate axes to which the principal components of the feature values effective for the image sorting are assigned, and performs the clustering of the principal components of the stored images in the feature value space (step ST7c). As the clustering method, K-means clustering algorithm or the like can be used. Incidentally, as for the clustering method, besides the foregoing K-means clustering algorithm, other methods can also be used.

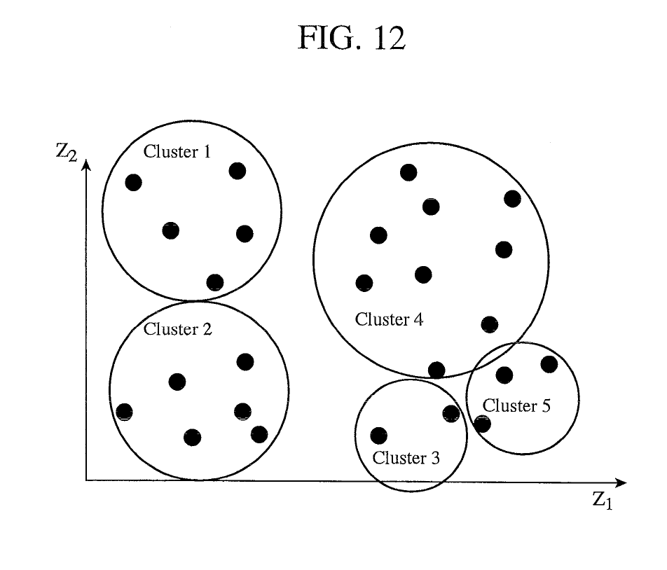

FIG. 12 is a diagram showing a result of the image sorting carried out in the two-dimensional feature value space using the principal component data on the feature values effective for the image sorting, in which the first principal component Z₁ of the feature value is plotted as the horizontal axis and the second principal component Z₂ as the vertical axis. In addition, closed circles indicate the principal component values of the feature values of the stored images sorted. In the example of FIG. 12, the images are sorted into five clusters.

The sort result display section 117, receiving the clustering result from the clustering executing section 116, requests the images sorted in accordance with it from the image storage section 101. Next, the sort result display section 117 receives the image data read out of the image storage section 101 in response to the request, and displays on the display screen (step ST8c). To display the sorted images, it is also possible to display them along with the feature value space used for the sorting.

For example, along with the points which correspond to the principal components of the feature values of the individual stored images in the two-dimensional feature value space shown in FIG. 12, thumbnails of the images can be arranged. If the feature value space used for the sorting is three-dimensional, images can be displayed in the three-dimensional feature value space in thumbnails.

As described above, according to the present embodiment 3, since it comprises the feature value extracting section 106 for extracting the feature values from the images of a plurality of targets to be sorted, a distance calculating section 113 for calculating the distances of the feature values between the images of the plurality of targets to be sorted, a distance analyzing section 114 for analyzing the distances calculated by the distance calculating section 113 and for selecting the feature values giving the similar features among the images of the plurality of targets to be sorted as the feature values effective for the image sorting, the feature value analyzing section 115 for carrying out the principal component analysis of the feature values effective for the image sorting, and the clustering executing section 116 for arranging the images to be sorted in the feature value space, in which the principal component analysis result of the feature values effective for the image sorting is assigned to the coordinate axes, and for sorting by clustering the images to be sorted in the feature value space, it can obtain the feature values effective for the image sorting from the stored image data, and cluster the stored images in the feature value space constructed using the effective feature values, thereby being able to achieve the image sorting effectively.

In addition, according to the present embodiment 3, since it comprises the sort result display section 117 for arranging the sort result obtained by the clustering executing section 116 in the feature value space and for displaying it on the display screen, a user can look at the sort result of the stored images in an organized manner.

Furthermore, according to the present embodiment 3, since the distance analyzing section 114 decides ranking of the validity of the feature values effective for the image sorting in accordance with the degree of similarity between the plurality of the images to be sorted, and the clustering executing section 116 sorts the images to be sorted using the feature values effective for the image sorting, the ranking of which is decided by the distance analyzing section 114, it can obtain a variety of image sorting results in accordance with the order of validity.

### Embodiment 4

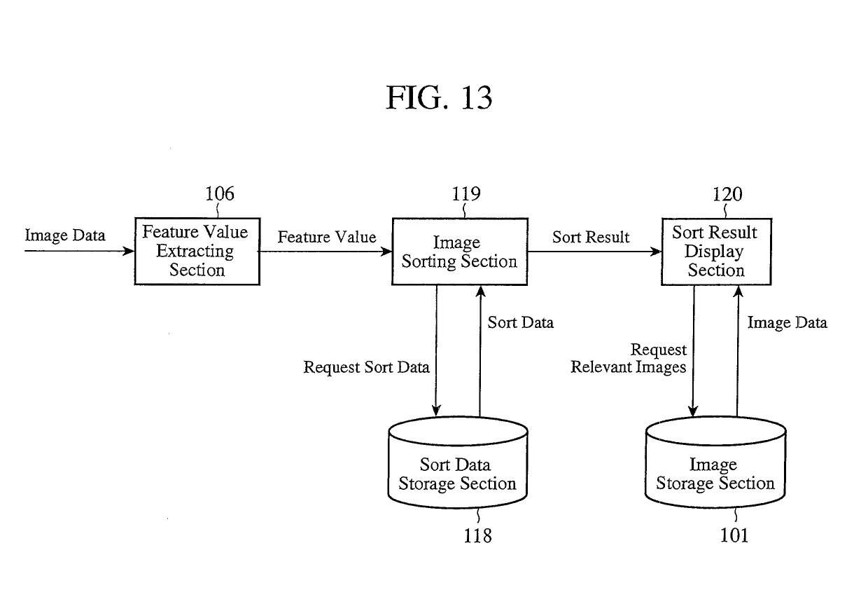

FIG. 13 is a block diagram showing a configuration of an image sorting apparatus of an embodiment 4 in accordance with the present invention. In FIG. 13, the image sorting apparatus of the embodiment 4 comprises an image storage section 101, a feature value extracting section 106, a sort data storage section 118, an image sorting section 119 and a sort result display section 120. The image storage section 101 is a storage section for storing image data having been sorted already. The sort data storage section 118 is a storage section for storing sort data on stored images in the image storage section 101. Here, the term “sort data” refers to data that determine sorting destinations of the stored images such as numeric data designating the dimensional axes of the feature value space in FIG. 12 shown in the embodiment 3.

The feature value extracting section 106 extracts feature values of the image data input from the outside of the apparatus. The feature values include, for example, a color histogram, rough arrangement of colors, frequency components, texture and its arrangement, shapes of objects in an image and so on. In addition, as an example of the feature value, there is an Edge Histogram as described above.

The image sorting section 119 sorts the image data newly input from the outside of the apparatus to any one of the sorting destinations using its feature values and sort data. The sort result display section 120 displays on the display screen the sort result by the image sorting section 119 or stored image data read out of the image storage section 101.

The foregoing feature value extracting section 106, image sorting section 119 and sort result display section 120 can be implemented as a concrete means in which software and hardware cooperate on a computer by causing the computer to read an image sorting program conforming the subject of the present invention and to control its operation.

In addition, the image storage section 101 and sort data storage section 118 can be constructed on the storage area of the storage device installed in the computer or on the storage area of the storage device of the external data server capable of data communication from the image sorting section 119 and sort result display section 120.

Next, the operation will be described.

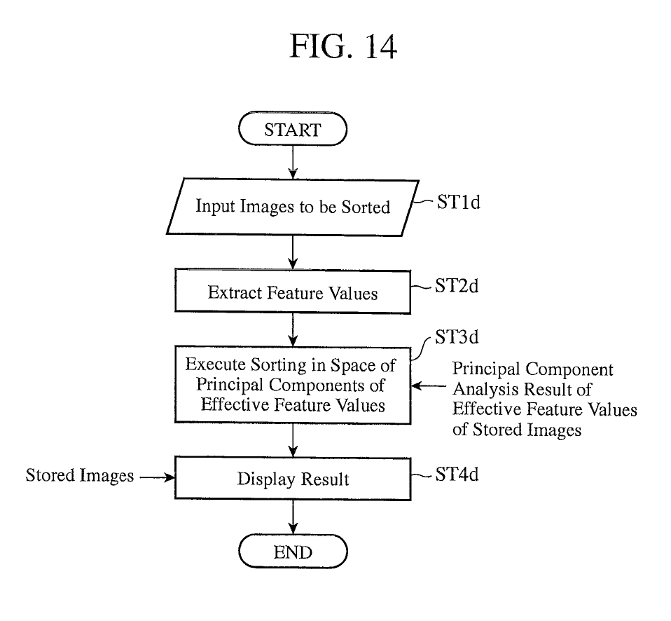

FIG. 14 is a flowchart showing a flow of the image sorting processing by the image sorting apparatus in FIG. 13, which will be described in detail with reference to FIG. 13 and FIG. 14. Incidentally, it is assumed in the following description that the stored images in the image storage section 101 have been sorted in advance by the image sorting apparatus of the embodiment 3, and that the sort data are stored in the sort data storage section 118. In addition, the sort data are numeric data that designate the dimensional axes of the feature value space using the principal components of the feature values effective for the image sorting shown in the embodiment 3.

First, the feature value extracting section 106 receives the image data from the outside of the apparatus (step ST1d), and extracts feature values from the image data (step ST2d). The information about the feature values extracted and the image data thereof are supplied from the feature value extracting section 106 to the image sorting section 119. The image sorting section 119, acquiring the feature values of the newly input image data, requests the sort data corresponding to the feature values of image data from the sort data storage section 118.

After that, the image sorting section 119, acquiring the sort data read out of the sort data storage section 118 in response to the request, constructs the feature value space having the dimensional axes specified by the sort data, and calculates the position of the image data in the feature value space in accordance with the feature values of the newly input image data. From the position of the image thus calculated, the image sorting section 119 decides to which cluster the newly input image belongs, thereby carrying out the sorting (step ST3d).

The sort result display section 120, receiving the sort result from the image sorting section 119, requests a stored image with the same sorting destination as the newly input image data from the image storage section 101. Next, the sort result display section 120, acquiring the image data read out of the image storage section 101 in response to the request, displays it on the display screen along with the newly input image (step ST4d). Incidentally, when displaying the sort resultant image, it is also possible to display it with the feature value space used for sorting by using the sort data.

As described above, according to the present embodiment 4, since it comprises the feature value extracting section 106 for extracting the feature value from an input image, the sort data storage section 118 for storing the sort data that specifies the feature value space with the coordinate axes, to which the principal component analysis result of the feature values effective for the image sorting is assigned, which are obtained by the image sorting of the image sorting apparatus shown in the embodiment 3, and the image sorting section 119 for deciding the position of the input image in the feature value space specified by the sort data using the feature value of the input image, and for sorting the input image in accordance with the decision result, it can easily sort the newly input image using the data having been sorted in advance.

In addition, according to the present embodiment 4, since it comprises the sort result display section 120 for displaying the sort result of the image sorting section 119 on the display screen after arranging it in the feature value space specified by the sort data, a user can look at the sort result of the input image in an organized manner.

Incidentally, the results of the searching and sorting shown in the embodiments 1-4 in accordance with the present invention are applicable to a validity decision of a web page, for example. To be concrete, to search for some statistical data, a decision is made as to whether an image in the page includes a graph or not using the present invention. This enables a user to search for a desired web page more easily.

### INDUSTRIAL APPLICABILITY

As described above, according to the present invention, it includes: an image storage section for storing search target images; a feature value storage section for storing feature values of the search target images; a principal component storage section for storing principal component analysis results of the feature values of the search target images; a feature value extracting section for extracting a feature value from a search key image; a distance calculating section for calculating distances between the feature values of the search target images stored in the feature value storage section and the feature value of the search key image; a distance analyzing section for analyzing the distances calculated by the distance calculating section, and for selecting a feature value of the search target images having a feature similar to the search key image as a feature value effective for the image search; and a search executing section for arranging the search target images in a feature value space with coordinate axes to which a principal component analysis result of the feature value effective for the image search is assigned, and for searching for an image similar to the search key image from within the feature value space. Thus, it selects a feature value effective for the image search from the feature values extracted from the search target images, and executes the image search in the feature value space constructed using the principal component analysis result of the feature value. Accordingly, it can obtain a search result a user intends appropriately and quickly, and is suitable for the application to a computer working as an image searching apparatus.

What is claimed is:

1. An image searching apparatus comprising:
an image storage section for storing search target images;
a feature value storage section for storing feature values of the search target images;
a principal component storage section for storing principal component analysis results of the feature values of the search target images;
a feature value extracting section for extracting a feature value from a search key image;
a distance calculating section for calculating distances between the feature values of the search target images stored in the feature value storage section and the feature value of the search key image;
a distance analyzing section for analyzing the distances calculated by the distance calculating section, and for selecting a feature value of the search target images having a feature similar to the search key image as a feature value effective for the image search; and
a search executing section for arranging the search target images in a feature value space with coordinate axes to which a principal component analysis result of the feature value effective for the image search is assigned, and for searching for an image similar to the search key image from within the feature value space.

2. The image searching apparatus according to claim 1, further comprising:
a search result display section for arranging the search result of the search executing section in the feature value space, and for displaying on a display screen.

3. The image searching apparatus according to claim 1, wherein
the distance analyzing section decides ranking of validity of the feature values effective for the image search in accordance with a degree of similarity to the search key image; and
the search executing section searches for an image similar to the search key image using the feature values effective for the image search which are ranked by the distance analyzing section.

4. The image searching apparatus according to claim 1, further comprising:
an input section through which information is input from outside of the apparatus, wherein
the search executing section alters the feature value effective for the image search in accordance with the information input through the input section.

5. The image searching apparatus according to claim 1, wherein
the search executing section carries out the image search using the feature value space with the coordinate axes to which first principal components among the principal component analysis result of the feature values effective for the image search are assigned.

6. An image sorting apparatus comprising:
a feature value extracting section for extracting feature values from a plurality of sort target images;
a distance calculating section for calculating distances of the feature values between the plurality of sort target images;
a distance analyzing section for analyzing the distances calculated by the distance calculating section, and for selecting a feature value giving a similar feature among the plurality of sort target images as a feature value effective for the image sorting;
a feature value analyzing section for carrying out principal component analysis of the feature value effective for the image sorting; and
a clustering executing section for arranging the sort target images in a feature value space with coordinate axes to which a principal component analysis result of the feature value effective for the image sorting is assigned, and for sorting the sort target images by clustering them in the feature value space.

7. The image sorting apparatus according to claim 6, further comprising:
a sort result display section for arranging a sort result of the clustering executing section in the feature value space, and for displaying on a display screen.

8. The image sorting apparatus according to claim 6, wherein
the distance analyzing section decides ranking of validity of the feature values effective for the image sorting in accordance with a degree of similarity among the plurality of the sort target images; and
the clustering executing section sorts the sort target images using the feature values effective for the image sorting which are ranked by the distance analyzing section.

9. The image sorting apparatus according to claim 6, wherein
the clustering executing section carries out the image sorting using the feature value space with the coordinate axes to which first principal components among the principal component analysis result of the feature values effective for the image sorting are assigned.

10. An image sorting apparatus comprising:
a feature value extracting section for extracting a feature value from an input image;
a sort data storage section for storing sort data specifying a feature value space with coordinate axes to which a principal component analysis result of the feature value effective for the image sorting is assigned, the principal component analysis result being obtained by the image sorting by the image sorting apparatus as defined in claim 6; and
an image sorting section for deciding a position of the input image in the feature value space specified by the sort data using the feature value of the input image, and for sorting the input image in accordance with the decision result.

11. The image sorting apparatus according to claim 10, further comprising:
a sort result display section for arranging a sort result of the image sorting section in the feature value space, and for displaying on a display screen.

12. An image searching method by the image searching apparatus as defined in claim 1, comprising:
a step of extracting a feature value from a search key image by the feature value extracting section;
a step of calculating distances between feature values of search target images and the feature value of the search key image by the distance calculating section;
a step of analyzing by the distance analyzing section the distances calculated by the distance calculating section, and of selecting a feature value of the search target images having a feature similar to the search key image as a feature value effective for the image search; and
a step of arranging by the search executing section the search target images in a feature value space with coordinate axes to which a principal component analysis result of the feature value effective for the image search is assigned, and of searching for an image similar to the search key image from within the feature value space.

13. The image searching method according to claim 12, further comprising:
a step of arranging a search result of the search executing section in the feature value space, and of displaying on a display screen by the search result display section.

14. An image sorting method by the image sorting apparatus as defined in claim 6, comprising:
a step of extracting feature values from a plurality of sort target images by the feature value extracting section;
a step of calculating distances of feature values between the plurality of sort target images by the distance calculating section;
a step of analyzing by the distance analyzing section the distances calculated by the distance calculating section, and of selecting feature values giving a similar feature among the plurality of sort target images as a feature value effective for the image search;
a step of carrying out principal component analysis of the feature value effective for the image sorting by the feature value analyzing section; and
a step of arranging by the clustering executing section the sort target images in a feature value space with coordinate axes to which a principal component analysis result of the feature value effective for the image search is assigned, and of carrying out sorting by clustering the sort target images in the feature value space.

15. The image sorting method according to claim 14, further comprising:
a step of arranging a sort result of the clustering executing section in the feature value space, and of displaying on a display screen by the sort result display section.

16. A program causing a computer to operate as:
an image storage section for storing search target images;
a feature value storage section for storing feature values of the search target images;
a principal component storage section for storing principal component analysis results of the feature values of the search target images;
a feature value extracting section for extracting a feature value from a search key image;
a distance calculating section for calculating distances between the feature values of the search target images stored in the feature value storage section and the feature value of the search key image;
a distance analyzing section for analyzing the distances calculated by the distance calculating section, and for selecting a feature value of the search target images having a feature similar to the search key image as a feature value effective for the image search; and
a search executing section for arranging the search target images in a feature value space with coordinate axes to which a principal component analysis result of the feature value effective for the image search is assigned, and for searching for an image similar to the search key image from within the feature value space.

17. A program causing a computer to operate as:
a feature value extracting section for extracting feature values from a plurality of sort target images;
a distance calculating section for calculating distances of the feature values between the plurality of sort target images;
a distance analyzing section for analyzing the distances calculated by the distance calculating section, and for selecting a feature value giving a similar feature among the plurality of sort target images as a feature value effective for the image sorting;
a feature value analyzing section for carrying out principal component analysis of the feature value effective for the image sorting; and
a clustering executing section for arranging the sort target images in a feature value space with coordinate axes to which a principal component analysis result of the feature value effective for the image sorting is assigned, and for sorting the sort target images by clustering them in the feature value space.

18. A program causing a computer to operate as:
a feature value extracting section for extracting a feature value from an input image;
a sort data storage section for storing sort data specifying a feature value space with coordinate axes to which a principal component analysis result of the feature value effective for the image sorting is assigned, the principal component analysis result being obtained by the image sorting by the image sorting apparatus as defined in claim 6; and
an image sorting section for deciding a position of the input image in the feature value space specified by the sort data using the feature value of the input image, and for sorting the input image in accordance with the decision result.
